(19) United States
(12) Patent Application Publication
(10) Pub. No.: US 2004/0213532 A1
(43) Pub. Date: Oct. 28, 2004

(54) Hybrid fiber-coaxial networks and broadband communications systems employing same

(76) Inventors: Frank Burkhead Wyatt II, Hickory, NC (US); Robert A. Wessels JR., Hickory, NC (US)

Correspondence Address: MYERS BIGEL SIBLEY & SAJOVEC, PO BOX 37428, RALEIGH, NC, 27627, US

(21) Appl. No.: 10/192,215

(22) Filed: Jul. 10, 2002

(51) Int. Cl. G02B 6/16; H04B 10/12

(52) U.S. Cl. 385/123; 725/129

(57) ABSTRACT

A hybrid fiber-coaxial cable (HFC) network includes a coaxial cable and an optical fiber connected with the coaxial cable, typically at a node. Together the coaxial cable and optical fiber define a transmission path. The optical fiber has a zero dispersion wavelength of about 1310 nm, a loss at 1385 nm that is less than its loss at 1310 nm and a chromatic dispersion of between 1.5 and 8.0 ps/nm-km in the 1.4 μm wavelength region. The HFC network is particularly suitable for use in a broadband communications system that comprises a coaxial cable and a wavelength-division multiplexed optical (WDM) waveguide system.

### FIELD OF THE INVENTION

The present invention relates generally to communications systems, and more specifically to systems employing hybrid fiber coaxial (HFC) networks.

### BACKGROUND OF THE INVENTION

Dispersion is a phenomenon whereby different optical wavelengths travel at different speeds through a dispersive media such as glass. Because a modulated carrier signal comprises many wavelengths, the optical signal that emerges from the distant end of a glass fiber is a distorted, flattened version of the signal that was launched into the near end. In the case of linear dispersion, this is solved by periodically providing compensation along an optical fiber route, with fewer compensation stages being preferred.

Conventional single mode fiber systems primarily operate in the wavelength region between 1285 and 1335 nanometers (nm) and have a zero-dispersion wavelength at about 1310 nm. However, the optical fiber used in such systems has traditionally been poorly suited for transmitting multiple closely spaced carrier wavelengths because of nonlinear interactions and mixing between the channels. The limiting form of such nonlinear phenomena—4-photon mixing (4PM)—is described in the literature (see, e.g., D. Marcuse et al., “Effect of Fiber Nonlinearity on Long-Distance Transmission,” Journal of Lightwave Technology, vol. 9, No. 1, January 1991, pp. 121-128). Briefly, 4PM appears as a fluctuating gain or loss due to constructive and destructive interference between different signal channels. The magnitude of 4PM is power dependent and may be reduced by decreasing launch power.

Multi-channel optical systems provide the most efficient use of an optical fiber and include wavelength-division multiplexers, which operate to combine an number of closely spaced channels (wavelength regions) onto a single optical path in one direction of transmission, and to separate them from the optical path in the other direction of transmission. Although conventional single mode fiber systems can provide WDM operation in the 1.55 μm wavelength region, there is typically too much linear dispersion (e.g., about 17 ps/nm-km) to be compensated for successful transmission. For example, compensation may be required every 50 to 100 kilometers, which is often an impractically short distance.

Contemplated uses of optical fiber include the transmission of all type of digital and analog information, both separately and together. Particular uses include data (such as Internet traffic) as well as broadcast television (TV) signals, which typically utilize amplitude modulated, vestigial-sideband (AM-VSB) modulation. Analog signals are inherently noise sensitive, and noise is readily observable in TV pictures. In particular, when multiple wavelengths such as WDM signals are transmitted on a single fiber, stimulated Raman scattering (SRS) causes energy to be transferred from the WDM signals into another wavelength region that is as much as 120 nm longer.

One optical transmission system that may be compatible with apparatus designed for conventional singlemode fiber systems, which may permit WDM operation without 4PM interference among WDM signals, and which may avoid SRS interference between WDM and analog TV signals, is disclosed in U.S. Pat. No. 6,205,268 to Chraplyvy et al., the disclosure of which is hereby incorporated herein by reference in its entirety, including terminology adopted therein. This system comprises a multiplexer that interconnects a plurality of digital information channels providing at least three channels of WDM signals in the 1.4 μm wavelength region in combination with one or more optical fibers, wherein the optical fiber has a length of greater than 10 kilometers, a zero dispersion wavelength of about 1310 nm, a loss at 1385 nm that is less than the loss at 1310 nm, and a chromatic dispersion of between 1.5 and 8.0 ps/nm-km in the 1.4 μm wavelength region. According to Chraplyvy et al., the disclosed system may provide improved performance such that long-distance (i.e., greater than 10 km) optical transmission over a range of practical bandwidths is achievable.

Fiber optic cable can typically carry more information over greater distances than coaxial cable, while coaxial cable can carry more information over greater distances than twisted pairs of copper cable. In the cable industry, a hybrid fiber-cable (HFC) network employs a combination of broadband linear optical fiber and coaxial cable. Such a network can allow delivery of many advanced two-way services in a cost-effective manner when compared with total conversion to a broadband digital optical network with significant time-division multiplex hardware included in the access plant.

### SUMMARY OF THE INVENTION

As a first aspect, the present invention is directed to a hybrid fiber-coaxial cable (HFC) network. The HFC network comprises a coaxial cable and an optical fiber connected with the coaxial cable, typically at a node. Together the coaxial cable and optical fiber define a transmission path. The optical fiber has a zero dispersion wavelength of about 1310 nm, a loss at 1385 nm that is less than its loss at 1310 nm and a chromatic dispersion of between 1.5 and 8.0 ps/nm-km in the 1.4 μm wavelength region. The optical fiber is able to transmit acceptable signals in other wavelength regions (such as 1.3 μm and 1.55 μm) as well as 1.4 μm.

The HFC network is particularly suitable for use in a communications system that comprises a coaxial cable and a wavelength-division multiplexed optical (WDM) waveguide system. The WDM waveguide system includes: a first transmitter for generating, modulating and multiplexing modulated channel carriers for introduction into a transmission line, the first transmitter being characterized by an average system wavelength within the 1.4 μm wavelength region; a first receiver for performing functions including demultiplexing modulated channel carriers; and a transmission line of optical fiber including at least one fiber span defined at one end by the first transmitter and at the other end by the first receiver, the optical fiber having a zero dispersion wavelength at about 1310 nm. Substantially all of the optical fiber defining the fiber span has a chromatic dispersion of between 1.5 and 8.0 ps/nm-km at the average system wavelength and a transmission loss at 1385 nm that is less than the transmission loss at 1310 nm. Also, one end of the optical fiber is connected with the first transmitter, and the other end of the optical fiber is connected to a node, and one end of the coaxial cable is connected to the node and the other end of the coaxial cable is connected to the second receiver. In this configuration, the communications system can deliver the high bandwidth, low interference, low noise signals characteristic of optical fibers to a location near the receiver, then deliver the signal over a short distance to the receiver utilizing pre-existing coaxial cable.

### BRIEF DESCRIPTION OF THE FIGURES

FIG. 1 is an end section view of an exemplary coaxial cable employed in an HFC network of the present invention.

FIG. 2 is an end section view of an exemplary optical cable employed in an HFC network of the present invention.

FIG. 3 is a schematic diagram of a communications system employing an HFC network of the present invention.

FIG. 4 is a schematic diagram of another embodiment of a communications system of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Instead, these embodiments are provided so that this disclosure will be thorough and complete, and will fully convey the scope of the invention to those skilled in the art. It will be understood that when an element (e.g., coaxial cable or cable jacket) is referred to as being “connected to” another element, it can be directly connected to the other element or intervening elements may also be present. In contrast, when an element is referred to as being “directly connected to” another element, there are no intervening elements present. Like numbers refer to like elements throughout. Some dimensions and thicknesses may be exaggerated for clarity.

Referring now to FIG. 1, a coaxial cable, designated broadly at 100, is illustrated therein. At its core, the coaxial cable 100 includes a conductor 110, typically formed of copper, copper-clad aluminum, or copper-clad steel. The conductor 110 is encircled by an insulation layer 112. The insulation layer 112 can be formed of any insulative material typically employed with conductors of this type, including polyvinylcliloride, polyvinylchloride alloys, polyethylene, polypropylene, and flame retardant materials such as fluorinated polymers (with foamed polyethylene being preferred). A shield 114 encircles the insulation layer 112. In the illustrated embodiment, the shield 114 is formed of layers of aluminum foil and aluminum braid, although those skilled in this art will appreciate that other materials, such as aluminum or copper formed by swaging or welding, may also be suitable for use. An optional self-sealing floodant or filling layer 116 covers the shield 114; a floodant layer is typically formed of a polymer-based material such as amorphous polypropylene, and a filling layer is typically formed of a gel mixture, such as one comprising mineral oil and fumed silica. The outer layer of the coaxial cable 100 is a jacket 118 that protects the inner components from environmental elements. The jacket 118 is typically formed of a tough, resilient, waterproof material such as polyvinylchloride, polyvinylchloride alloys, polyethylene, polypropylene and flame retardant materials such as FEP or another fluorinated polymer.

Those skilled in this art will appreciate that the coaxial cable 100 can take any coaxial cable configuration known to those skilled in this art. Alternative configurations and materials are illustrated and/or described, for example, in Coax Cable Catalog, Residential/Commercial Broadband Cable Catalog and Trunk & Distribution Cable Product Catalog, available from CommScope, Inc., and at www.commscope.com. Typically a 75 ohm cable is preferred, but in some embodiments like wireless applications, a 50 ohm cable is preferred, and other resistance levels for the cable 100 may also be used. It is also preferred that the coaxial cable 100 have a bandwidth of at least 1 GHz, more preferably at least 1.5 GHz, and most preferably at least 2 GHz, and it is also preferred that the cable 100 operate below its cut-off frequency (which is typically dependent on the physical structure of the cable). It is also preferred that the coaxial cable 100 have a return loss of at least −20 dB, more preferably at least −25 dB, and most preferably −30 dB, and/or the coaxial cable 100 should have a return loss that achieves optimal or 30 desired bandwidth.

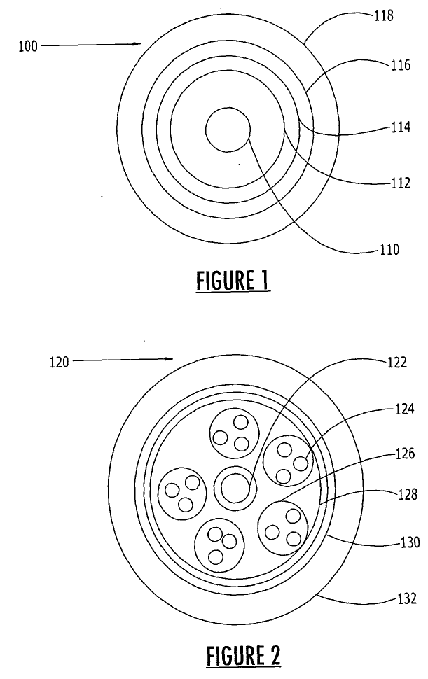

Referring now to FIG. 2, an optical fiber cable, designated broadly at 120, is illustrated therein. The optical fiber cable includes a dielectric core 122 (typically included for strength) and a plurality of dielectric tubes 126 (typically formed of a protective material such as polypropylene, polyethylene, or PBT), each of which houses a plurality (three are shown herein) of optical fibers 124. The optical fibers 124 are preferably constructed and formed in the manner described in U.S. Pat. No. 6,205,268 to Chraplyvy et al. (incorporated by reference hereinabove). More specifically, the optical fibers 124 should have the following performance characteristics: a loss at 1385 nm that is less than that at 1310 nm; a chromatic dispersion of between 1.5 and 8.0 ps/nm-km in the 1.4 μm region, and a zero dispersion wavelength of about 1310 nm. As noted in the Chraplyvy patent, the optical fibers 124 may be particularly advantageous in lengths greater than 10 kilometers. Notably, the fibers 124 may be used for other wavelength regions, such as the 1.3 μm and 1.55 μm wavelength regions as well as the 1.4 μm wavelength region; moreover, the fibers 124 can include multiple wavelength regions to achieve optimal or desired bandwidth.

Still referring to FIG. 2, the buffer tubes 126 surrounding the optical fibers 124 are encased with a layer of water-blocking aramid yarns 128. A floodant or filling material such as that described above may be included within the volume bounded by the aramid yarn layer 128. Dual jackets 130, 132 then cover the layer 128. The inner jacket 126 is typically formed of an armoring material (such as steel), and the outer jacket 128 is typically formed of a tough, resilient material such as polyethylene or polypropylene.

Those skilled in this art will appreciate that other materials may be employed in the optical fiber cable 120. In particularly, the layers surrounding the optical fibers 124 and the buffer tubes 126 may be modified, changed, omitted, or supplemented depending on the specific application within a communications system. Some alternative optical fiber cable configurations, which may include, but are not limited to, non-armored, stranded tube, and ribbon configurations, are illustrated in Optical Reach Fiber Optic Cable Products Catalog, available from CommScope, Inc. and at www.commscope.com.

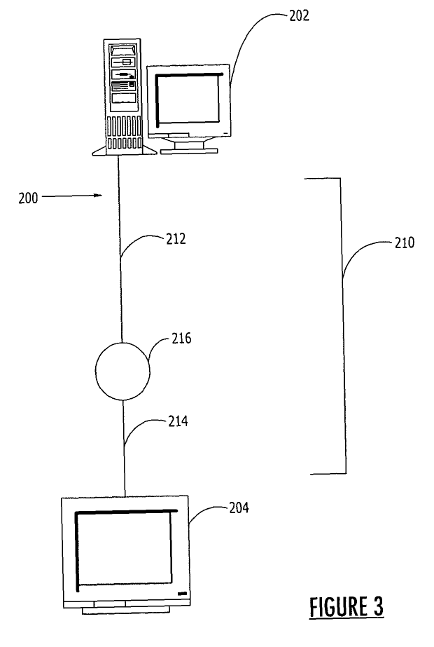

Referring now to FIG. 3, a communications system, designated broadly at 200, is illustrated therein. The communications system 200 includes one or more transmitters 202 and one or more receivers 204 that are interconnected with an HFC network 210. The HFC network 210 includes an optical fiber portion 212 that includes optical fiber of the type described above and a coaxial cable portion 214 that includes coaxial cable of the type described above. In the illustrated system 200, the optical fiber portion 212 is connected to the transmitter 202 and travels to a node 216 located near the receiver 204, where the signal is converted from an optical signal to an electrical signal by techniques known to those skilled in this art. The coaxial cable portion 214 travels from the node 216 to the receiver 204.

The optical fiber portion 212, although illustrated as a single transmission line, more typically includes a number of discrete optical fiber lengths that travel either (a) from the transmitter 202 to an intermediate node or hub, (b) between intermediate nodes or hubs, or (c) from an intermediate node or hub to the node 216. The presence of the intermediate modes can provide significant flexibility to the system for operation, maintenance, modification, and enhancement. It will also be understood by those skilled in this art that other components, such as amplifiers, multiplexers, demultiplexers, wave-division multiplexers and demultiplexers, and the like may also be included in the optical fiber portion 212. It should also be noted that, although only a single transmitter 202 is illustrated herein, in many embodiments multiple transmitters 202 will feed signals into the HFC network 210. Also, in some embodiments a single transmitter 202 may feed multiple signals into the optical fiber portion 212, or may feed a signal of multiple bandwidths into the optical fiber portion 212.

In traveling from the node 216 to the receiver 204, the coaxial cable portion 214 typically has a relatively short travel path (ordinarily on the order of 1,000 to 6,000 feet); for example, it may only travel from a central location within a neighborhood. In this manner, the communications system 200 can utilize pre-existing coaxial cable while taking advantage of the higher bandwidth and lower interference and noise offered by the optical fiber portion 212 over the large majority of the travel path between the transmitter 202 and the receiver 204. This configuration can significantly reduce cost compared to the installation of entirely new optical fiber systems connected with the receiver 204 while still achieving acceptable bandwidth performance and services. It should be noted that, although only a single coaxial cable portion 214 is illustrated herein, in many embodiments multiple coaxial cable portions will extend from the node 216 to multiple receivers 204, and that multiple receivers 204 may also receive signals from a common coaxial cable portion 214.

Exemplary devices that may serve as transmitters 202 include broadband video devices, cable television devices and modems, telephony devices, data distribution devices, Internet servers, and the like. Exemplary devices that may serve as receivers 204 include the types of devices that would typically receive signals from these transmitters, including televisions, cable television boxes and modems, telephones, wireless networks, personal computers, handheld devices, interactive gaming devices, and the like. It should also be understood that, although the transmitters 202 is illustrated as a transmitter and the receiver 204 described as receivers, signals can be processed in either direction between the transmitter 202 and the receiver 204.

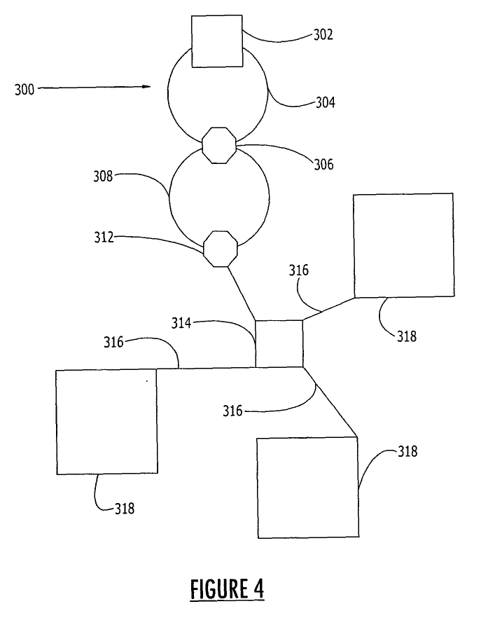

Referring now to FIG. 4, another embodiment of a communications system, designated broadly at 300, is illustrated therein. The communications system 300 includes a head end device 302 that is in communication with a primary fiber optic cable ring 304. The primary ring 304 is in communication with a primary hub 306, which in turn is in communication with a secondary fiber optic cable ring 308. A secondary hub 310 is in communication with the secondary ring 308 and with a remote fiber optic shunt 312 that extends to meet a platform 314. Multiple coaxial cables 316 are in communication with the platform 314 and extend to three destination receivers 318.

Those skilled in this art will appreciate that the communications system 300 may take many other forms. For example, additional hubs may be present on the primary or secondary rings, and additional rings may also be present. Also, more destinations may be in communication with the platform 314, and additional platforms (i.e., nodes) may also be included.

It should also be understood that, although the headend device 302 is illustrated as a transmitter and the destination receivers 318 described as receivers, signals can be processed in either direction between the headend and the destinations. Exemplary transmitters and receivers are as described above for the embodiment of FIG. 3.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A hybrid fiber-coaxial cable (HFC) network, comprising:
a coaxial cable; and
an optical fiber in communication with the coaxial cable, such that together the coaxial cable and optical fiber define a transmission path, the optical fiber having a zero dispersion wavelength of about 1310 nm, a loss at 1385 nm that is less than its loss at 1310 nm and a chromatic dispersion of between 1.5 and 8.0 ps/nm-km in the 1.4 μm wavelength region.

2. The HFC network defined in claim 1, further comprising a multiplexer in communication with the optical fiber.

3. The HFC network defined in claim 1, further comprising a wave-division multiplexer in communication with the optical fiber.

4. The HFC network defined in claim 1, wherein the optical fiber travels at least 10 kilometers along the travel path, and the coaxial cable travels less than 6,000 feet along the travel path.

5. The HFC network defined in claim 1, further comprising a second coaxial cable, and wherein the optical fiber is in communication with the coaxial cables at a node.

6. The HFC network defined in claim 1, wherein the coaxial cable is a 75 ohm coaxial cable.

7. The HFC network defined in claim 1, wherein the coaxial cable has a bandwidth of at least 1 GHz.

8. The HFC network defined in claim 1, wherein the coaxial cable has a bandwidth of at least 1.5 GHz.

9. The HFC network defined in claim 1, wherein the coaxial cable has a bandwidth of at least 2 GHz.

10. The HFC network defined in claim 1, wherein the coaxial cable has a return loss of at least −20 dB.

11. The HFC network defined in claim 1, wherein the coaxial cable has a return loss of at least −25 dB.

12. The HFC network defined in claim 1, wherein the coaxial cable has a return loss of at least −30 dB.

13. A communications system, comprising:
a coaxial cable;
a wavelength-division multiplexed optical waveguide system, comprising:
a first transmitter that is configured to generate, modulate and multiplex modulated channel carriers for introduction into a transmission line, the first transmitter being characterized by an average system wavelength within the 1.4 μm wavelength region;
a first receiver that is configured to perform functions including demultiplexing modulated channel carriers;
a transmission line of optical fiber including at least one fiber span defined at one end by the first transmitter and at the other end by the first receiver, the optical fiber having a zero dispersion wavelength at about 1310 nm;
wherein substantially all of the optical fiber defining the fiber span has a chromatic dispersion of between 1.5 and 8.0 ps/nm-km at the average system wavelength and a transmission loss at 1385 nm that is less than the transmission loss at 1310 nm; and
wherein one end of the optical fiber is in communication with the first transmitter, and the other end of the optical fiber is in communication with a node, and one end of the coaxial cable is in communication with the node and the other end of the coaxial cable is in communication with the second receiver.

14. The communications system defined in claim 13, wherein a second transmitter is in communication with the optical fiber, and a second receiver is in communication with the coaxial cable.

15. The communications system defined in claim 13, further comprising a second coaxial cable in communcation at one end with the node and at the other end with a third receiver.

16. The communications system defined in claim 13, wherein the first transmitter is selected from the group consisting of broadband video devices, cable television devices, telephony devices, and data devices.

17. The communications system defined in claim 13, wherein the first receiver is selected from the group consisting of televisions, cable television boxes, telephones, wireless networks, handheld devices, and personal computers.

18. The communications system defined in claim 13, wherein the first transmitter is configured to transmit signals in the 1.4 μm wavelength region and in at least one other wavelength region.

19. The communications system defined in claim 13, wherein the coaxial cable has a bandwidth of at least 1 GHz.

20. The communications system defined in claim 13, wherein the coaxial cable has a bandwidth of at least 1.5 GHz.

21. The communications system defined in claim 13, wherein the coaxial cable has a bandwidth of at least 2 GHz.

22. The communications system defined in claim 13, wherein the coaxial cable has a return loss of at least —20 dB.

23. The communications system defined in claim 13, wherein the coaxial cable has a return loss of at least −25 dB.

24. The communications system defined in claim 13, wherein the coaxial cable has a return loss of at least −30 dB.

25. A method of transmitting signals from a transmitter to a receiver, comprising:
transmitting a signal from a transmitter through an optical fiber transmission line to a node, the optical fiber transmission line including at least one fiber span defined at one end by the first transmitter and at the other end by the first receiver, the optical fiber having a zero dispersion wavelength at about 1310 nm, wherein substantially all of the optical fiber defining the fiber span has a chromatic dispersion of between 1.5 and 8.0 ps/nm-km at the average system wavelength and a transmission loss at 1385 nm that is less than the transmission loss at 1310 nm; and
transmitting the signal from the node to a receiver through a coaxial cable.

26. The method defined in claim 25, wherein a second coaxial cable is in communication with the node.

27. The method defined in claim 25, wherein the coaxial cable has a bandwidth of at least 1 GHz.

28. The method defined in claim 25, wherein the coaxial cable has a bandwidth of at least 1.5 GHz.

29. The method defined in claim 25, wherein the coaxial cable has a bandwidth of at least 2 GHz.

30. The method defined in claim 25, wherein the coaxial cable has a return loss of at least −20 dB.

31. The method defined in claim 25, wherein the coaxial cable has a return loss of at least −25 dB.

32. The method defined in claim 25, wherein the coaxial cable has a return loss of at least −30 dB.

33. The method defined in claim 25, wherein the coaxial cable is configured to operate below its cut-off frequency.

34. The method defined in claim 25, wherein the coaxial cable is configured to have a return loss that achieves optimal bandwidth.

35. The HFC network defined in claim 1, wherein the coaxial cable is configured to operate below its cut-off frequency.

36. The HFC network defined in claim 1, wherein the coaxial cable is configured to have a return loss that achieves optimal bandwidth.

37. The communications system defined in claim 16, wherein the coaxial cable is configured to operate below its cut-off frequency.

38. The communications system defined in claim 16, wherein the coaxial cable is configured to have a return loss that achieves optimal bandwidth.
